(19) United States
(12) Patent Application Publication
(10) Pub. No.: US 2026/0019815 A1
(43) Pub. Date: Jan. 15, 2026

(54) RESOURCE MANAGEMENT FOR RADIO ACCESS NETWORK UTILIZING VIRTUALIZED DISTRIBUTED UNITS

(71) Applicant: DISH Wireless L.L.C., Englewood, CO (US)

(72) Inventors: Mehdi ALASTI, Arlington, VA (US); Minho SONG, Ashburn, VA (US); Sourabh GUPTA, Ashburn, VA (US)

(73) Assignee: DISH Wireless L.L.C., Englewood, CO (US)

(21) Appl. No.: 18/768,187

(22) Filed: Jul. 10, 2024

(51) Int. Cl. H04W 16/10; H04W 88/08

(52) U.S. Cl. CPC H04W 16/10; H04W 88/085

(57) ABSTRACT

A method and system for managing shared resources in Radio Access Networks (RANs) involve managing resource distribution among network resources using virtual Distributed Units (DUs) and a Media Access Control (MAC) layer. The resources are scheduled jointly with a schedular, and a Virtual Machine (VM) hosts the virtual DUs and the schedular on a physical DU. The VM facilitates the sharing of the physical DU between the virtual DUs. Network resources include operator cores or Centralized Unit-Control Planes (CU-CPs) connected to the virtual DUs, and potentially a Radio Unit (RU). The schedular can dynamically share physical DU resources and reserve bandwidth for the virtual DUs, adjusting allocations as needed.

### FIELD

The present teachings pertain to a sharing a physical Distributed Units (DUs) connected to distinct Centralized Units (CUs) of multiple operators in a New Radio/Fifth Generation (NR/5G) network. Each operator maintains ownership and management of their own CUs, Core network components and the like, while sharing some RUs and/or DUs to improve efficiency and resource utilization.

### BACKGROUND

Previous approaches to managing resources in a shared Radio Access Network (RAN) have typically involved allocating DUs independently for different network resources, leading to suboptimal resource utilization. In traditional RAN architectures, the use of multiple Media Access Control (MAC) layers with distinct Distributed Units (DUs) for different network resources can complicate resource management and coordination, leading to inefficiencies in resource scheduling and utilization. The prior art fails to provide a comprehensive solution that combines the features described in this disclosure.

A Rel-10.00 O-RAN supports shared-RU based on semi-static channel BW reservation. However, a Rel-10.00 O-RAN does not support dynamic resource allocation for a DU. The dynamic resource allocation can be achieved using a Shared-DU among multiple operators. However, each physical DU is mapped to a single CU-CP (3GPP TS 38.401).

The prior art supports a MOCN model where all gNB (CU-CP, CU-UP(s), DU(s) and RU(s)) resources are all shared between multiple operators. However, the MOCN model is inflexible as all the gNB resources must be shared among the operators reducing an operator's ability to configure their network with exclusive resources. The present teachings disclose a method to share a DU and/or a RU across multiple operators, while configuring some of the operator's resources for exclusive use by the operator.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In some aspects, the techniques described herein relate to a method for managing shared resources in Radio Access Networks (RANs), the method including: managing resource distribution among a first network resources using a first virtual Distributed Unit (DU) including a first Media Access Control (MAC) layer and among a second network resources using a second virtual DU including a second MAC layer; scheduling, jointly with a schedular, the first network resources and the second network resources; and hosting a Virtual Machine (VM), the first virtual DU, the second virtual DU and the schedular on a physical DU, wherein the VM manages a sharing of the physical DU between the first virtual DU and the second virtual DU.

In some aspects, the techniques described herein relate to a method, wherein the first network resources include a first Centralized Unit-Control Plane (CU-CP) connected to the first virtual DU and the second network resources includes a second CU-CP connected to the second virtual DU.

In some aspects, the techniques described herein relate to a method, wherein the first network resources include a first operator core connected to the first virtual DU via the first CU-CP and the second network resources includes a second operator core connected to the second virtual DU via the second CU-CP.

In some aspects, the techniques described herein relate to a method, wherein the first virtual DU connects the first CU-CP to a shared Radio Unit (RU) and the second virtual DU connects the second CU-CP to the shared RU.

In some aspects, the techniques described herein relate to a method, wherein the shared RU supports the first virtual DU and the second virtual DU based on a semi-static channel bandwidth reservation on the shared RU.

In some aspects, the techniques described herein relate to a method, wherein the first network resources include a first RU connected to the first virtual DU and the second network resources includes a second RU connected to the second virtual DU.

In some aspects, the techniques described herein relate to a method, wherein the schedular provides dynamic sharing of resources of a RU between the first virtual DU and the second virtual DU.

In some aspects, the techniques described herein relate to a method, wherein the schedular reserves a first bandwidth of a physical DU bandwidth for the first virtual DU, a second bandwidth of the physical DU bandwidth for the second DU, and the schedular avails the second virtual DU of an unused bandwidth of the first bandwidth when the first virtual DU uses less than the first bandwidth at the RU.

In some aspects, the techniques described herein relate to a method, wherein the first network resources include a first core, the first virtual DU and a shared RU and the second network resources include a second core, the second virtual DU and the shared RU, and the first network resources are operated by a first operator and the second network resources are operated by a second operator.

In some aspects, the techniques described herein relate to a method, wherein the first operator is a guest operator of the second operator.

In some aspects, the techniques described herein relate to a system to manage shared resources in Radio Access Networks (RANs), the system including: a first virtual Distributed Unit (DU) including a first Media Access Control (MAC) layer and the first DU is configured to manage resource distribution among a first network resources; a second virtual DU including a second MAC layer and the second DU is configured to manage resource distribution among a second network resources; a schedular configured to jointly schedule the first network resources and the second network resources; and a physical DU configured to host a Virtual Machine (VM), the first virtual DU, the second virtual DU and the schedular, wherein the VM manages a sharing of the physical DU between the first virtual DU and the second virtual DU.

In some aspects, the techniques described herein relate to a system, wherein the first network resources include a first Centralized Unit-Control Plane (CU-CP) connected to the first virtual DU and the second network resources includes a second CU-CP connected to the second virtual DU.

In some aspects, the techniques described herein relate to a system, wherein the first network resources include a first operator core connected to the first virtual DU via the first CU-CP and the second network resources includes a second operator core connected to the second virtual DU via the second CU-CP.

In some aspects, the techniques described herein relate to a system, wherein the first virtual DU connects the first CU-CP to a shared Radio Unit (RU) and the second virtual DU connects the second CU-CP to the shared RU.

In some aspects, the techniques described herein relate to a system, wherein the shared RU supports the first virtual DU and the second virtual DU based on a semi-static channel bandwidth reservation on the shared RU.

In some aspects, the techniques described herein relate to a system, wherein the first network resources include a first RU connected to the first virtual DU and the second network resources includes a second RU connected to the second virtual DU.

In some aspects, the techniques described herein relate to a system, wherein the schedular provides dynamic sharing of resources of a RU between the first virtual DU and the second virtual DU.

In some aspects, the techniques described herein relate to a system, wherein the schedular reserves a first bandwidth of a physical DU bandwidth for the first virtual DU, a second bandwidth of the physical DU bandwidth for the second DU, and the schedular avails the second virtual DU of an unused bandwidth of the first bandwidth when the first virtual DU uses less than the first bandwidth at the RU.

In some aspects, the techniques described herein relate to a system, wherein the first network resources include a first core, the first virtual DU and a shared RU and the second network resources include a second core, the second virtual DU and the shared RU, and the first network resources are operated by a first operator and the second network resources are operated by a second operator.

In some aspects, the techniques described herein relate to a system, wherein the first operator is a guest operator of the second operator.

Additional features will be set forth in the description that follows, and in part will be apparent from the description, or may be learned by practice of what is described.

### DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates an embodiment of a hybrid cloud cellular network.

FIG. 2 illustrates an embodiment of a 5G Core.

FIG. 3 illustrates an embodiment of a hybrid cloud cellular network architecture.

FIG. 4 illustrates a system to manage shared resources in RANs according to various embodiments.

FIG. 4A illustrates joint scheduling of two MAC layers by a joint schedular according to various embodiments.

FIG. 5 illustrates a flowchart of a method for managing shared resources in RANs, according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The present teachings may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

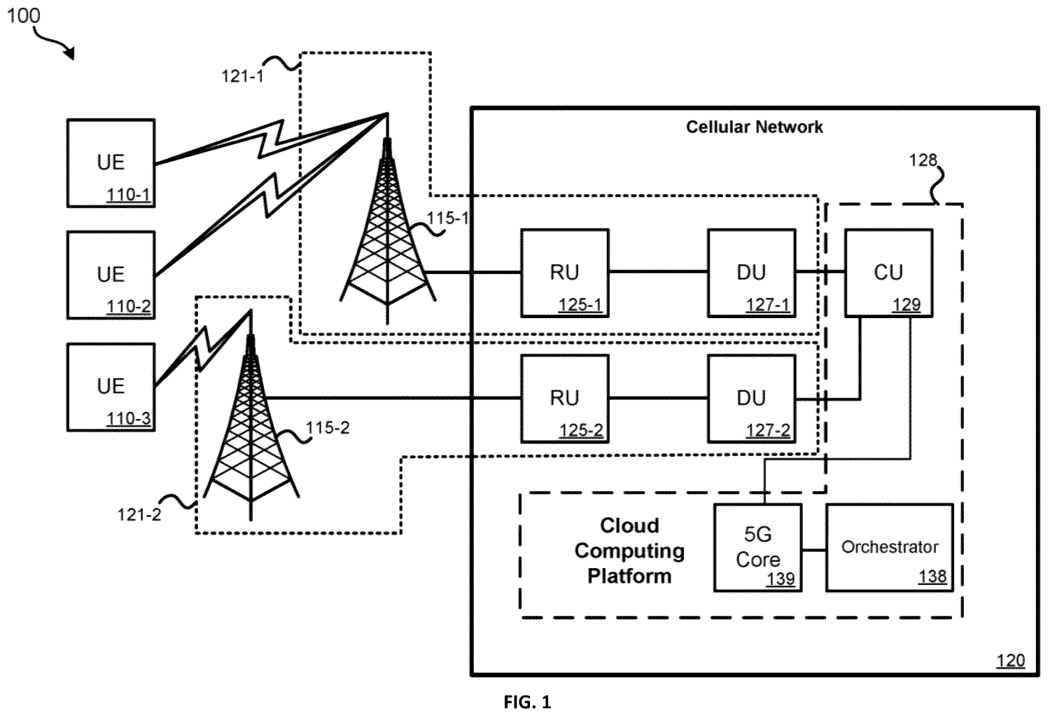

FIG. 1 illustrates a block diagram of a hybrid cellular network system (“system 100”). System 100 can include a 5G New Radio (NR) cellular network; other types of cellular networks, such as 6G, 7G, o., may also be possible. System 100 can include: UE 110 (UE 110-1, UE 110-2, UE 110-3); structure 115; cellular network 120; radio units 125 (“RUs 125”); distributed units 127 (“DUs 127”); centralized unit 129 (“CU 129”); 5G core 139; and orchestrator 138. FIG. 1 represents a component-level view. In an open radio access network (O-RAN), most components, except for components that need to receive and transmit RF, can be implemented as specialized software executed on general-purpose hardware or servers. For at least some components, a separate cloud-service computing platform provider may maintain the hardware. Therefore, the cellular network operator may operate some hardware (such as, RUs and local computing resources on which DUs are executed) connected with a cloud-computing platform on which other cellular network functions, such as the core and CUs are executed.

UE 110 can represent several types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE 110 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, or the like. Depending on the location of individual UEs, UE 110 may use RF to communicate with various BSs of cellular network 120. BS 121 may include an RU (e.g., RU 125-1) and a DU (e.g., DU 127-1). Two BSs 121 (BS 121- 1 and BS 121-2) are illustrated. BS 121-1 can include: structure 115-1, RU 125-1, and DU 127-1. Structure 115-1 may be any structure to which one or more antennas (not illustrated) of the BS are mounted. Structure 115-1 may be a dedicated cellular tower, a building, a water tower, or any other man-made or natural structure to which one or more antennas can be mounted to provide cellular coverage to a geographic area. Similarly, BS 121-2 can include: structure 115-2, RU 125-2, and DU 127-2.

Real-world implementations of system 100 can include many (e.g., thousands) of BSs and many CUs and 5G core 139. BS 121-1 can include one or more antennas that allow RUs 125 to communicate wirelessly with UEs 110. RUs 125 can represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices.

One or more RUs, such as RU 125-1, may communicate with DU 127-1. As an example, at a cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 127-1, may communicate with CU 129. Collectively, an RU, DU, and CU create a gNB, which serves as the radio access network (RAN) of cellular network 120. CU 129 can communicate with 5G core 139. The specific architecture of cellular network 120 can vary by embodiment. Edge cloud server systems (not illustrated) outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, and CU 129. Functionality of such components can be co-located or located at disparate physical server systems. For example, certain components of 5G core 139 may be co-located with components of CU 129.

In a possible virtualized implementation, CU 129, 5G core 139, and/or orchestrator 138 can be implemented as software being executed by general-purpose computing equipment on a cloud-computing platform 128, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where 5G core 139 is executed, while other functions are executed at a separate server system or on a separate cloud computing system. In the illustrated embodiment of system 100, cloud-computing platform 128 can execute CU 129, 5G core 139, and orchestrator 138. The cloud-computing platform 128 can be a third-party cloud-based computing platform or a cloud-based computing platform operated by the same entity that operates the RAN. Cloud-based computing platform 128 may have the ability to devote additional hardware resources to cloud-based cellular network components or implement additional instances of such components when requested.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new DU for test, orchestrator 138 can perform a pipeline of calling the DU code from a software repository incorporated as part of, or separate from cellular network 120, pulling corresponding configuration files (e.g. helm charts), creating Kubernetes nodes/pods, loading DU containers, configuring the DU, and activating other support functions (e.g. Prometheus, instances/connections to test tools). While this instantiation of a DU may be triggered by orchestrator 138, a chaos test system may introduce false DU container images in the repo, may introduce latency or memory issues in Kubernetes, may vary traffic messaging, and/or create other “chaos” in order to conduct the test. That is, chaos test system is not only connected to a DU but is connected to all the layers and systems above and below a DU, as an example.

Kubernetes, Docker®, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The traditional OSS/BSS stack exists above orchestrator 138. Chaos testing of these components, as well as other higher layer custom-built components. Such components can be required sources of information and agents for testing at the service/app/solution layer. One aim of chaos testing is to verify the business intent (service level objectives (SLOs) and SLAs) of the solution. Therefore, if we commit to an SLA with certain key performance indicators (KPIs), chaos testing can allow measuring of whether those KPIs are being met and assess resiliency of the system across all layers to meeting them.

A cellular network slice functions as a virtual network operating on an underlying physical cellular network. Operating on cellular network 120 is some number of cellular network slices, such as hundreds or thousands of network slices. Communication bandwidth and computing resources of the underlying physical network can be reserved for individual network slices, thus allowing the individual network slices to reliably meet defined SLA requirements. By controlling the location and amount of computing and communication resources allocated to a network slice, the QoS and QoE for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus optimization between performance and cost is desirable.

Particular parameters that can be set for a cellular network slice can include uplink bandwidth per UE; downlink bandwidth per UE; aggregate uplink bandwidth for a client; aggregate downlink bandwidth for the client; maximum latency; access to particular services; and maximum permissible jitter.

Particular network slices may only be reserved in particular geographic regions. For instance, a first set of network slices may be present at RU 125-1 and DU 127-1, a second set of network slices, which may only partially overlap or may be different from the first set, may be reserved at RU 125-2 and DU 127-2.

Further, particular cellular network slices may include multiple defined slice layers. Each layer within a network slice may be used to define parameters and other network configurations for particular types of data. For instance, high-priority data sent by a UE may be mapped to a layer having higher QoS parameters and network configurations than lower-priority data sent by the UE that is mapped to a second layer having less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

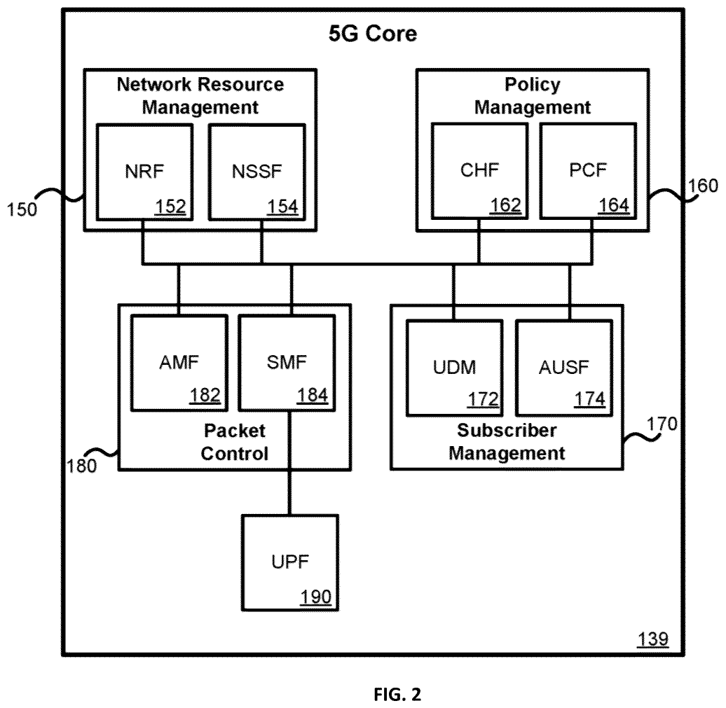

FIG. 2 illustrates a block diagram of a cellular network core, which can represent 5G core 139. 5G core 139 can be implemented on a cloud-computing platform. 5G core 139 can be physically distributed across data centers or located at a central national data center (NDC), and can perform various core functions of the cellular network. 5G core 139 can include: network resource management components 150; policy management components 160; subscriber management components 170; and packet control components 180. Individual components may communicate on a bus, thus allowing various components of 5G core 139 to communicate with each other directly. 5G core 139 is simplified to show some key components. Implementations can involve additional other components.

Network resource management components 150 can include: Network Repository Function (NRF) 152 and Network Slice Selection Function (NSSF) 154. NRF 152 can allow 5G network functions (NFs) to register and discover each other via a standards-based application programming interface (API). NSSF 154 can be used by AMF 182 to assist with the selection of a network slice that will serve a particular UE.

Policy management components 160 can include: Charging Function (CHF) 162 and Policy Control Function (PCF) 164. CHF 162 allows charging services to be offered to authorized network functions. Converged online and offline charging can be supported. PCF 164 allows for policy control functions and the related 5G signaling interfaces to be supported.

Subscriber management components 170 can include: Unified Data Management (UDM) 172 and Authentication Server Function (AUSF) 174. UDM 172 can allow for generation of authentication vectors, user identification handling, NF registration management, and retrieval of UE individual subscription data for slice selection. AUSF 174 performs authentication with UE.

Packet control components 180 can include: Access and Mobility Management Function (AMF) 182 and Session Management Function (SMF) 184. AMF 182 can receive connection-and session-related information from UE and is responsible for handling connection and mobility management tasks. SMF 184 is responsible for interacting with the decoupled data plane by creating, updating and removing Protocol Data Unit (PDU) sessions, and managing session context with the User Plane Function (UPF).

User plane function (UPF) 190 can be responsible for packet routing and forwarding, packet inspection, QoS handling, and external PDU sessions for interconnecting with a Data Network (DN) 195 (e.g., the Internet) or various access networks 197. Access networks 197 can include the RAN of cellular network 120 of FIG. 1.

The functions illustrated in FIG. 2 as part of 5G core 139 are merely exemplary. Many more or distinct functions may be implemented in the cellular network core and may vary by slice. The amount of computing resources devoted to a particular function can vary by slice.

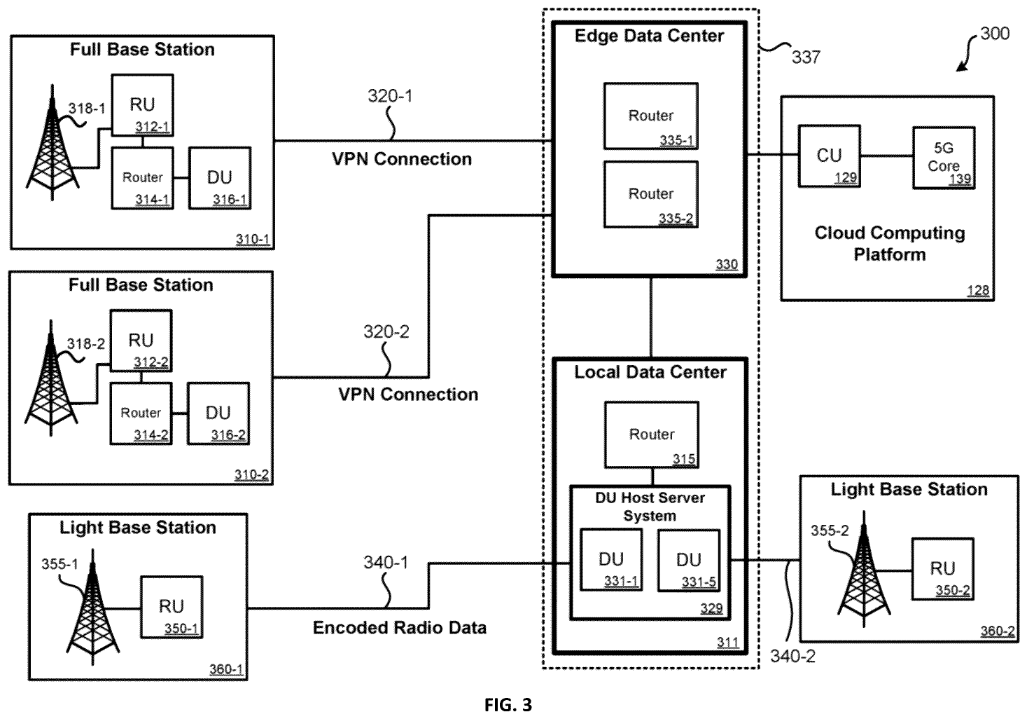

FIG. 3 illustrates an embodiment of hybrid cellular network system 300 (“system 300”) that includes hybrid use of local and remote DUs in communication with a cloud computing platform that hosts the cellular network core. System 300 can include: LDC 311; light BSs 360; full BSs 310; VLAN connections 320; edge data center 330 (“EDC 230”); CU 129; and 5G core 139, which are executed on cloud computing platform 128. In system 300, some base stations, referred to as “full base stations,” have DUs implemented locally at each BS. In contrast, a “light base station” includes structure (e.g., structures 355) and a local radio unit (e.g., RUs 350), but a DU implemented remotely at a geographically separated LDC. In system 300, either light BSs 360 or full BSs 310 may be referred to as a cell site.

LDC 311 can serve to host DU host server system 329, which can host multiple DUs 331 which are remote from corresponding light base stations 360. For example, DU 331-1 can perform the DU functionality for light base station 360-1. DUs with DU host server system 329 can communicate with each other as needed.

LDC 311 can be connected with EDC 330. In some embodiments, LDC 370 and EDC 330 may be co-located in a same data center or near each other, such as within 250 meters. EDC 330 can include multiple routers, such as routers 335, and can serve as a hub for multiple full BSs 310 and one or more LDCs 311. EDC 330 may be so named because it primarily handles the routing of data and does not host any RAN or cellular core functions. In a cloud- computing cellular network implementation at least some components, such as CU 129 and functions of 5G core 139, may be hosted on cloud computing platform 128. EDC 330 may serve as the past point over which the cellular network operator maintains physical control; higher-level functions of CU 129 and 5G core 139 can be executed in the cloud. In other embodiments, CU 129 and 5G core 139 may be hosted using hardware maintained by the cellular network provider, which may be in the same or a different data center from EDC 330.

Full BSs 310, which include on-site DUs 316, may connect with the cellular network through EDC 330. A full BS, such as full BS 310-1, can include: RU 312-1; router 314-1; DU 316-1; and structure 318-1. Router 314-1 may have a connection to a high bandwidth communication link with EDC 330. Router 314-1 may route data between DU 316-1 and EDC 330 and between DU 316-1 and RU 312-1. In some embodiments, RU 312-1 and one or more antennas are mounted to structure 318-1, while router 314-1 and DU 316-1 are housed at a base of structure 318-1. Full BS 310-2 functions similarly to full BS 310-1. While two full BSs 310 and two light BSs 360 are illustrated in FIG. 3, it should be understood that these numbers of BSs are merely for exemplary purposes; in other embodiments, the number of each type of BS may be greater or fewer.

While encoded radio data is transmitted via the fiber optic connections 340 between light BSs 360 and LDC 370, connection 320-1 between full BSs 310 and EDC 330 may occur over a fiber network. For example, while the connection between light BS 360-1 and LDC 370 can be understood as a dedicated point-to-point communication link on which addressing is not necessary, full BS 310-1 may operate on a fiber network on which addressing is required. Multiprotocol label switching (MPLS) segment routing (SR) may be used to perform routing over a network (e.g., fiber optic network) between full BS 310-1 and EDC 330. Such segment routing can allow for network nodes to steer packetized data based on a list of instructions carried in the packet header. This arrangement allows for the source from where the packet originated to define a route through one or more nodes that will be taken to cause the packet to arrive at its destination. Use of SR can help ensure network performance guarantees and can allow for network resources to be efficiently used. Other full BSs may use the same types of communication link as full BS 310-1. While MPLS SR can be used for the network connection between full BSs 310 and EDC 330, it should be understood that other protocols and non-fiber-based networks can be used for connections 320.

For communications across connection 320-1, a virtual local area network (VLAN) may be established between DU 316-1 and EDC 330, when a fiber network that may also be used by other entities is used. The encryption of this VLAN helps ensure the security of the data transmitted over the fiber network.

Since light BSs 360 are close to LDC 370, typically in a dense urban environment, use of a dedicated point-to-point fiber connection can be straight-forward to install or obtain (e.g., from a network provider that has available dark fiber or fiber on which bandwidth can be reserved). However, in a less dense environment, where full BSs 310 can be used, a point-to-point fiber connection may be cost-prohibitive or otherwise unavailable. As such, the fiber network on which MPLS SR is performed and the VLAN connection is established can be used instead. Further, the total amount of upstream and/or downstream data from a light BS to an LDC may be significantly greater than the amount of upstream and/or downstream data from a DU of a full BS to EDC 337, thus requiring a dedicated fiber optic connection to satisfy the bandwidth requirements of light BSs.

To perform chaos testing, a small portion of the cellular network can be simulated and tested, followed by larger portions of the cellular network as needed to verify functionality and robustness. Once satisfied as to performance in a test environment, testing can be performed in a restricted production environment, followed by release into the general production environment. On each of these levels, some amount of chaos testing can be performed.

An exemplary operator/organization offers a shared “RU+Power Amplifier/filter/wiring+antenna+spectrum” with other (guest) operators/organizations. A guest operator leases access to the shared-RU in a specific geographical area, with a specific BW during a specific period of time. A guest operator owns/manages their own DUs, CUs, core, o. in their cloud platforms and may only share the shared-RU. There is a need for operators to share DUs.

In the present teachings, a single schedular is used on a physical DU across operators to support dynamic resource sharing. The dynamic resource sharing of a DU may provide a highest statistical multiplexing gain. A O-RAN DU implements the functional blocks of L2 layer of a 5G NR protocol stack in SA (Standalone) mode (7.2.x split option). These layers primarily include NR RLC, NR MAC/schedular and NR high PHY layer.

A Distributed Unit (DU) is a key component of the 5G mobile communications standard and network architecture. The DU is responsible for Radio processing and control, Managing and controlling Radio Units (RUs), handling radio frequency (RF) processing tasks, Providing synchronization signals, Data organization and management, Interacting with the Radio Unit (RU), and Latency reduction and efficiency. The DU supports the lower layers of the 5G communication protocol stack, including the Radio Link Control (RLC), Medium Access Control (MAC), and Higher Physical Layer (H-PHY). A lower Physical Layer (L-PHY) may be implemented by a RU. The CU supports the higher layers of the protocol stack, while the DU supports the lower layers. The interface between the CU and the DU is called F1. CU provides centralized processing and control functions for the component of the 5G radio access network. With the prior art 3GPP gNB architecture, each physical DU can only be mapped to one CU CP and DU sharing is not supported.

In some embodiments, RUs may be software virtualized on white Box hardware. In some embodiments, a DU may be virtualized on the cloud or collocated with a RU on the same or different HW platform in the cell site

The 5G Medium Access Control (MAC) layer, as defined in 3GPP Technical Specification 38.321, plays a crucial role in managing radio resources and ensuring efficient communication within 5G networks. It operates just above the physical layer (PHY) and below the radio link control (RLC) and packet data convergence protocol (PDCP) layers. In 5G, the MAC layer interacts closely with the PHY layer to optimize resource utilization. The MAC layer includes a schedular for resource allocation and scheduling, among other things. The schedular allocates resources, for example, time, frequency and code resources, to connected User Equipment (UEs) to facilitate efficient data transmission. The schedular also determines which connected UEs can transmit data and when, considering numerous factors like Quality of Service (QoS) requirements, traffic types, and channel conditions. The schedular handles Hybrid Automatic Repeat reQuest (HARQ) processes, enabling retransmissions of data packets in case of errors. The schedular manages logical channels for control information exchange between the MAC layer and higher-layer protocols. The schedular multiplexes and de-multiplexes data flows from different UEs onto the shared radio resources. The schedular MAC plays a role in the allocation and signaling of Physical Downlink Control Channel (PDCCH) resources for control information transmission.

MAC functions are divided into User Plane (UP) and Control Plane (CP) categories, each serving specific purposes. The UP MAC manages the transmission and reception of user data, while the CP MAC handles control signaling and coordination between the UE and the network. The MAC layer adapts dynamically to changing radio conditions, traffic patterns, and network requirements, ensuring efficient resource utilization and QoS provision. The MAC layer interacts with higher layers, such as the RLC and PDCP layers, to ensure end-to-end data delivery and protocol convergence.

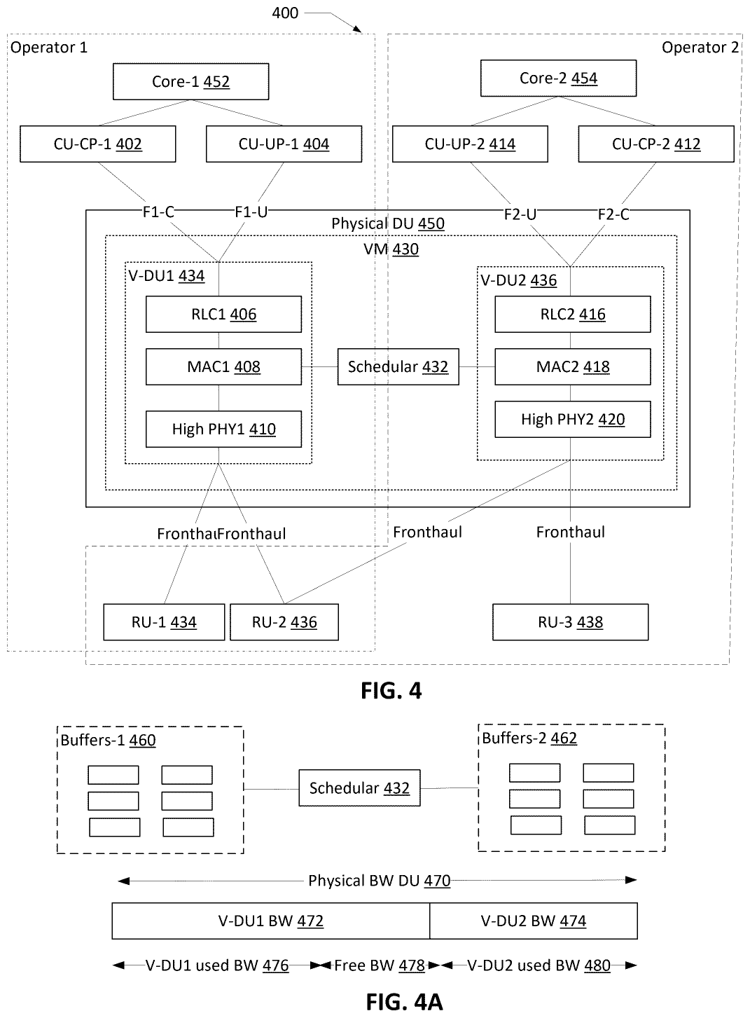

FIG. 4 illustrates a system to manage shared resources RANs according to various embodiments.

A system 400 to manage resources in a shared RAN include a physical DU 450 executing a Virtual Machine (VM) 430 to host two virtual DUs, V-DU1 434 and V-DU2 436. VM 430 also hosts a schedular 432 (a schedular) to dynamically allocate the resources of the physical DU 450. VM 430 creates a cohesive system that supports the dynamic and efficient management of shared network resources. VM 430 oversees and regulates the distribution of resources of physical DU 450 between V-DU1 434 and V-DU2 436, ensuring that the infrastructure is utilized efficiently. Additionally, the first network resources are operated by a first operator, and the second network resources are operated by a second operator. This delineation of ownership and management responsibilities allows each operator to maintain control over their respective CUs and Core components (core-1 452 and core-2 454) while sharing other resources. With the use of VM 430, physical DU 450 provides a collaborative network infrastructure where an operator or organization can offer shared RAN capabilities to other entities, promoting resource sharing and potentially reducing operational costs.

For operator 1, V-DU1 434 connects to CU-CP-1 402 via a F1-C interface and to CU-UP-1 404 via a F1-U interface to shared RUs, namely RU-1 434 and RU-2 436, via a fronthaul interface. For operator 2, V-DU2 436 connects to CU-CP-2 412 via a F2-C interface and to CU-UP-2 414 via a F2-U interface to shared RUs (RU-1 434 and RU-2 436) and an unshared RU (namely, RU-3 438) over a fronthaul interface. As illustrated, RUs connected to virtual DUs may be shared or unshared. V-DU1 434 includes layers RLC1 406, MAC1 408 and high PHY1 410. V-DU2 436 includes layers RLC2 416, MAC2 418 and high PHY2 420.

FIG. 4A illustrates joint scheduling of two MAC layers by a joint schedular according to various embodiments.

Schedular 432 performs dynamic sharing of resources of the physical DU 450 between the V-DU1 434 and the V-DU2 436. MAC1 408 is responsible for managing buffers-1 460 (see FIG. 4A) and schedules actions for buffers-1 460 using schedular 432 that may directly access buffers-1 460. MAC2 418 is responsible for managing and scheduling buffers-2 462 (see FIG. 4A) using schedular 432 that may directly access buffers-2b 462. With the schedular 432 accessing buffers-1 460 and buffers-2 462, MAC1 408 and MAC2 418, share resources of the physical DU 450 for dynamically allocating operator 1's network resources and operator 2's network resources.

Schedular 432 may manage the shared resources efficiently with dynamic resource sharing to achieve a maximal statistical multiplexing gain. The schedular 432 ensures that the physical DU's resources are allocated flexibly and in real-time based on the current demands. In some embodiments, a planned use of a physical DU BW 470 may be divided into or reserved as a V-DU1 BW 472 and V-DU2 BW 474. A current use of physical DU BW 470 may be V-DU1 used BW 476 and V-DU2 used BW 480 for V-DU1 434 and V-DU2 436, respectively. When V-DU1 434 uses less of the physical DU BW 470 than V-DU1 used BW 476, schedular 432 may permit use of (make available) a free BW 478 to V-DU2 436. This ensures optimal bandwidth usage by allowing unused portions of a reserved BW for one virtual DU to be utilized by the other virtual DU. As such, multiple operators utilize the same hardware while managing their own network components, ensuring flexible and efficient use of the infrastructure.

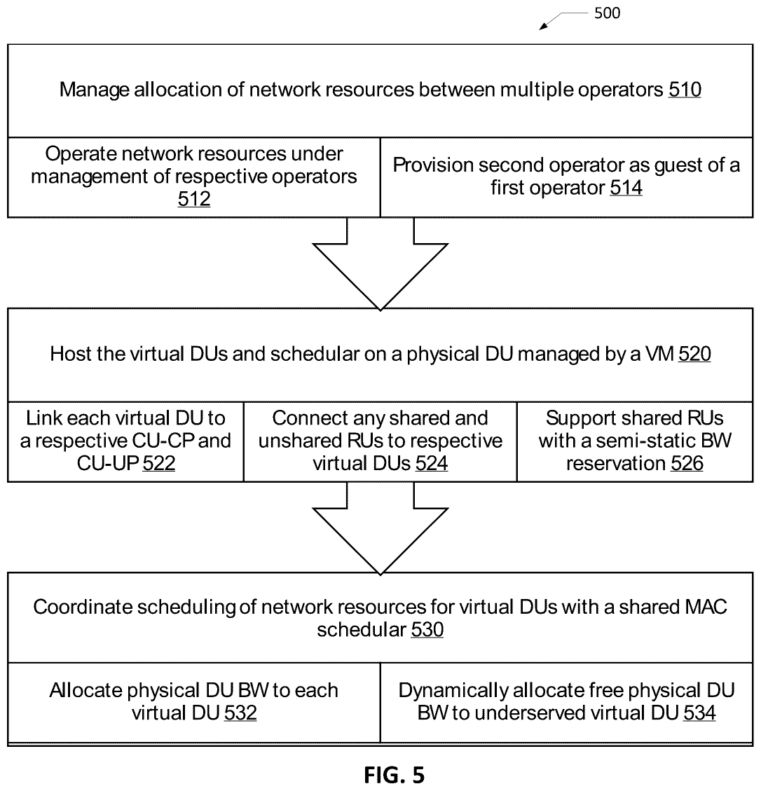

FIG. 5 illustrates a flowchart of a method for managing shared resources in RANs, according to various embodiments.

A method 500 manages resources in a shared Radio Access Network (RAN) by splitting one physical DU into two virtual DUs, using a single schedular for dynamic resource sharing, and connecting each virtual DU to their respective operator's control units. This method enables multiple operators to share the same hardware while maintaining control over their own network components, resulting in efficient and flexible resource utilization.

Method 500 includes operation 510 to manage allocation of network resources between multiple operators. Operation 510 enables multiple operators to share the same physical infrastructure while maintaining control over their respective network components. A physical DU is split into virtual DUs, for example, V-DU1 and V-DU2, to enable the sharing of physical resources between multiple operators or network segments. This splitting allows for flexible and efficient use of the infrastructure.

Method 500 may include operation 512 to operate the network resources under management of respective operators. The first network resources include a first operator core, a first CU-CP, a first CU-UP and first RUs connected to the first virtual DU. These connections establish links between the first operator's network resources. The first operator core, V-DU1, and the operators are involved in this connection, ensuring that the first operator can manage their network components while sharing the physical infrastructure. Analogous connections are established for the second virtual DU to the second operator's resources.

In some embodiments, method 500 includes operation 516 to provision a second operator as guest of a first operator. Even as a guest, the second operator is responsible for maintaining its core. The guest operator leases access to the shared RUs and physical DUs in a specific geographical area, with a specific bandwidth (BW) during a specific period of time. This arrangement allows the guest operator to utilize the shared resources without compromising control over their core network components.

Method 500 may include operation 520 to host the virtual DUs and schedular on a physical DU managed by a VM. The VM creates separate operational entities for different operators from a single hardware unit. This configuration allocates and controls network resources for specific network segments or operators. The VM manages the sharing of the physical DU's resources between the two virtual DUs, ensuring that each virtual DU can operate independently while sharing the underlying hardware. The VM hosts the first virtual DU including a first MAC layer, the second virtual DU including a second MAC layer, and a schedular (MAC) on the physical DU.

Method 500 includes an operation 522 to link each virtual DU to a respective CU-CP and CU-UP. The MAC layer and the first virtual Distributed Unit (DU) are responsible for allocating and controlling network resources for a first network segment or operator. The first virtual DU, referred to as V-DU1, connects to the Centralized Unit-Control Plane (CU-CP) of operator 1, known as CU CP-1. This connection facilitates the sharing of DUs between different operators, each connecting to their respective CU. The setup delineates the ownership and management responsibilities of the operators for their respective CU and Core components while sharing other resources. Similarly, a second MAC layer and a second virtual DU manage resource distribution for another specific network segment or operator. The second virtual DU, referred to as V-DU1, connects to the CU-CP of operator 2, known as CU CP-2. This connection also supports the sharing of DUs between different operators, each connecting to their respective CU.

Method 500 includes operation 524 to connect any shared and unshared RUs to the respective virtual DUs. The connections to the RUs provide shared and unshared (dedicated) RUs for each virtual DU, allowing for tailored radio resource management while sharing the physical infrastructure with other operators. For example, the first virtual DU connects the first CU-CP to a shared Radio Unit (RU) and the second virtual DU connects the second CU-CP to the shared RU. The shared RU is a component that enables the connection of both the first and second virtual DUs to a common radio unit, facilitating network resource management.

Method 500 includes operation 526 to support shared RUs with a semi-static BW reservation. The shared RU supports the first virtual DU and the second virtual DU based on a semi-static channel bandwidth reservation on the shared RU. The purpose of semi-static channel bandwidth reservation is to support shared-RU configurations in O-RAN systems, allowing for predetermined bandwidth allocation among operators. Rel-10.00 O-RAN supports shared-RU based on semi-static channel BW reservation. This ensures that the shared RU can accommodate both virtual DUs with some level of flexibility.

Method 500 includes operation 530 to coordinate scheduling of network resources for virtual DUs with a shared schedular. The schedular coordinates the allocation and usage of network resources between the first and second network resources. The schedular is shared between MAC1 and MAC2 to manage the shared resources efficiently between the two operators. The use of a single schedular supports dynamic resource sharing, achieving statistical multiplexing gain. This method ensures that the resources are utilized efficiently and flexibly, adapting to the current demands of each operator.

Method 500 may include operation 532 to allocate physical DU BW to each virtual DU. The schedular may be setup to allocate/reserve up to a first bandwidth of a physical DU bandwidth for the first virtual DU and up to a second bandwidth of the physical DU bandwidth for the second DU. In some embodiments, the schedular uses the reserved bandwidth as a hard cap for each corresponding virtual DU. The purpose of using a single schedular is to facilitate dynamic resource sharing among operators, which results in statistical multiplexing gain. This method supports dynamic resource sharing, allowing multiple operators to utilize the same hardware while managing their own network components. The schedular provides efficient bandwidth utilization and a statistical multiplexing gain. This enables resource sharing among multiple operators while allowing them to maintain control over their own CU and Core infrastructure.

In some embodiments, method 500 may include operation 534 to dynamically allocate any free physical DU BW to an underserved virtual DU. In some embodiments, when the first virtual DU needs less of the physical DU bandwidth than the first bandwidth, the schedular avails the second virtual DU of a portion of the first bandwidth. This ensures that the available bandwidth is utilized optimally, allowing for flexible and real-time allocation of the physical DU's resources to the virtual DUs based on current demands. Dynamically sharing the physical DU resources between the first virtual DU and the second virtual DU with the schedular provides efficient resource management and achieves a high statistical multiplexing gain. This allows multiple operators to utilize the same hardware while managing their own network components, ensuring flexible and efficient use of the infrastructure.

Having described preferred embodiments of a system and method (which are intended to be illustrative and not limiting), it is noted that modifications and variations can be made by persons skilled in the art considering the above teachings. It is therefore to be understood that changes may be made in the embodiments disclosed which are within the scope of the invention as outlined by the appended claims. Having thus described aspects of the invention, with the details and particularity required by the patent laws, what is claimed and desired protected by Letters Patent is set forth in the appended claims.

We claim as our invention:

1. A method for managing shared resources in Radio Access Networks (RANs), the method comprising:
managing resource distribution among a first network resources using a first virtual Distributed Unit (DU) comprising a first Media Access Control (MAC) layer and among a second network resources using a second virtual DU comprising a second MAC layer;
scheduling, jointly with a schedular, the first network resources and the second network resources; and
hosting a Virtual Machine (VM), the first virtual DU, the second virtual DU and the schedular on a physical DU,
wherein the VM manages a sharing of the physical DU between the first virtual DU and the second virtual DU.

2. The method of claim 1, wherein the first network resources comprise a first Centralized Unit-Control Plane (CU-CP) connected to the first virtual DU and the second network resources comprises a second CU-CP connected to the second virtual DU.

3. The method of claim 2, wherein the first network resources comprise a first operator core connected to the first virtual DU via the first CU-CP and the second network resources comprises a second operator core connected to the second virtual DU via the second CU-CP.

4. The method of claim 2, wherein the first virtual DU connects the first CU-CP to a shared Radio Unit (RU) and the second virtual DU connects the second CU-CP to the shared RU.

5. The method of claim 4, wherein the shared RU supports the first virtual DU and the second virtual DU based on a semi-static channel bandwidth reservation on the shared RU.

6. The method of claim 1, wherein the first network resources comprise a first RU connected to the first virtual DU and the second network resources comprises a second RU connected to the second virtual DU.

7. The method of claim 1, wherein the schedular provides dynamic sharing of resources of a RU between the first virtual DU and the second virtual DU.

8. The method of claim 7, wherein the schedular reserves a first bandwidth of a physical DU bandwidth for the first virtual DU, a second bandwidth of the physical DU bandwidth for the second DU, and the schedular avails the second virtual DU of an unused bandwidth of the first bandwidth when the first virtual DU uses less than the first bandwidth at the RU.

9. The method of claim 1, wherein the first network resources comprise a first core, the first virtual DU and a shared RU and the second network resources comprise a second core, the second virtual DU and the shared RU, and the first network resources are operated by a first operator and the second network resources are operated by a second operator.

10. The method of claim 9, wherein the first operator is a guest operator of the second operator.

11. A system to manage shared resources in Radio Access Networks (RANs), the system comprising:
a first virtual Distributed Unit (DU) comprising a first Media Access Control (MAC) layer and the first DU is configured to manage resource distribution among a first network resources;
a second virtual DU comprising a second MAC layer and the second DU is configured to manage resource distribution among a second network resources;
a schedular configured to jointly schedule the first network resources and the second network resources; and
a physical DU configured to host a Virtual Machine (VM), the first virtual DU, the second virtual DU and the schedular,
wherein the VM manages a sharing of the physical DU between the first virtual DU and the second virtual DU.

12. The system of claim 11, wherein the first network resources comprise a first Centralized Unit-Control Plane (CU-CP) connected to the first virtual DU and the second network resources comprises a second CU-CP connected to the second virtual DU.

13. The system of claim 12, wherein the first network resources comprise a first operator core connected to the first virtual DU via the first CU-CP and the second network resources comprises a second operator core connected to the second virtual DU via the second CU-CP.

14. The system of claim 12, wherein the first virtual DU connects the first CU-CP to a shared Radio Unit (RU) and the second virtual DU connects the second CU-CP to the shared RU.

15. The system of claim 14, wherein the shared RU supports the first virtual DU and the second virtual DU based on a semi-static channel bandwidth reservation on the shared RU.

16. The system of claim 11, wherein the first network resources comprise a first RU connected to the first virtual DU and the second network resources comprises a second RU connected to the second virtual DU.

17. The system of claim 11, wherein the schedular provides dynamic sharing of resources of a RU between the first virtual DU and the second virtual DU.

18. The system of claim 17, wherein the schedular reserves a first bandwidth of a physical DU bandwidth for the first virtual DU, a second bandwidth of the physical DU bandwidth for the second DU, and the schedular avails the second virtual DU of an unused bandwidth of the first bandwidth when the first virtual DU uses less than the first bandwidth at the RU.

19. The system of claim 11, wherein the first network resources comprise a first core, the first virtual DU and a shared RU and the second network resources comprise a second core, the second virtual DU and the shared RU, and the first network resources are operated by a first operator and the second network resources are operated by a second operator.

20. The system of claim 19. wherein the first operator is a guest operator of the second operator.
